(19) United States
(12) Patent Application Publication
(10) Pub. No.: US 2011/0105011 A1
(43) Pub. Date: May 5, 2011

(54) SHEET METAL FRAME FOR ACCESS DOOR

(75) Inventors: Harold J. DUBENSKY, Columbia, PA (US); Mark D. MOYERS, Red Lion, PA (US); Tim J. ROGGE, Eau Claire, WI (US); Todd CARLSON, Eau Claire, WI (US); Robert D. MYERS, Landisville, PA (US); Robert E. BENDER, Red Lion, PA (US); Martin D. WEATHERD, Stanberry, MO (US)

(73) Assignee: JOHNSON CONTROLS TECHNOLOGY COMPANY, Holland, MI (US)

(21) Appl. No.: 12/846,938

(22) Filed: Jul. 30, 2010

Related U.S. Application Data
(60) Provisional application No. 61/256,539, filed on Oct. 30, 2009.

(51) Int. Cl. F24F 13/18; E06B 5/00; B23P 17/00

(52) U.S. Cl. 454/195; 52/205; 29/897

(57) ABSTRACT

An access door assembly for use in an air-handling unit provides a structural member that prevents over-compression of gaskets by the access door panel for improved gasket life and effectiveness and increases the thermal efficiency properties or the air-handling unit. The access door assembly has a “Z” shaped cross-section and includes a gasket channel and an anti-compression leg having a rim to prevent over compression of the gasket located in the gasket channel.

### CROSS REFERENCE TO RELATED PATENT APPLICATIONS

This application claims priority from and the benefit of U.S. Provisional Application No. 61/256,539, entitled “Sheet Metal Frame for Access Door,” filed Oct. 30, 2009, which is hereby incorporated by reference.

### FIELD OF INVENTION

The present disclosure is directed to air handling unit access door assemblies. More particularly, the disclosure relates to a sheet metal access door frame having a “Z” shaped cross-section and an additional flange or anti-compression leg to prevent over-compression of the gasket by the access door.

### BACKGROUND

As components of an air conditioning system, many commercial buildings have an air handling unit or units, and the air handling units are typically placed on the roofs of buildings or located in a mechanical room inside of the building. A typical air handling unit includes an enclosure with one or more doors to allow personnel to gain access to and to maintain the equipment inside the enclosure. The air handling unit typically encloses heating, ventilation, and air conditioning (HVAC) equipment. Because the HVAC equipment is used to maintain the building's temperature, it is important that the enclosure and doors of the air handling unit are substantially fluid tight. Roof top air handling units must also be able to withstand external environmental conditions, such as the high external air pressure associated with gale force winds. In addition, the air handling units typically are insulated with thermal insulation to minimize heat exchange between the atmospheric conditions exterior to the unit and controlled conditions maintained within the unit.

One method of manufacturing access door frames includes providing a structural member that is cut into segments that are abutted at the ends to form a framework for receiving a door, typically in the shape of a rectangle. The door frame is constructed from extruded aluminum that is joined together using butt-joints. To help secure the segments of the structural member in position to form the framework, mechanical fasteners, such as screws, are driven through the corner edge of one segment and into the corner edge of another segment edge of an adjacent segment. Door panels are then secured to each side of the framework to form a door. To prevent heat exchange and fluid leakage a gasket is placed between the door panels and structural member. A problem with the current design is that the gasket can be and often is, over-compressed by the door panel when the access door assembly is closed and latched to seal the air handling unit. Over-compression of the gasket causes the gasket to prematurely fail and wear resulting in air leakage and heat exchange between the outside and inside of the air handling unit.

Therefore what is needed is a high-efficiency air handling unit with higher structural strength and more thermal efficiency properties. This may be provided by a structural member that prevents over-compression of gaskets by the access door panels for improved gasket life and effectiveness, while still providing an effective seal between the access door panels and the structural member.

### SUMMARY

The present disclosure is directed to an air handling unit comprising a plurality of walls, one of the walls having an aperture with a perimeter, and at least one access door assembly located in the perimeter of one of the plurality of walls. The access door assembly further includes a door panel, a structural member surroundingly encompassing the door panel, and a gasket positioned between the poor panel and the gasket. The structural member includes a plurality of frame pieces and the plurality of frame pieces further include a mounting flange, a segment, a first rolled surface adjacent to the mounting flange and adjacent to the segment, a gasket channel, a second rolled surface adjacent to the segment and adjacent to the gasket channel, an anti-compression leg, and a third rolled surface adjacent to the gasket channel and adjacent to the anti-compression leg. The gasket is disposed in the gasket channel and adjacent to the anti-compression leg and the segment. The anti-compression leg is operative to substantially prevent the door panel from over-compressing the gasket. A fastening means is included to attach the access door assembly to the perimeter of the wall.

The present disclosure is further directed to an access door assembly including a door panel, a structural member attached to a perimeter of a wall opening, the structural member surroundingly encompassing the door panel, and a gasket. The structural member includes a plurality of frame pieces. The plurality of frame pieces further include a mounting flange, a segment, a first rolled surface adjacent to the mounting flange and the segment, a gasket channel, a second rolled surface adjacent to the segment and the gasket channel, an anti-compression leg, and a third rolled surface adjacent to the gasket channel and the anti-compression leg. The gasket is disposed in the gasket channel and adjacent to the anti-compression leg and the segment. The anti-compression leg is operative to substantially prevent the door panel from over compressing the gasket disposed in the gasket channel.

The present disclosure is further directed to a method of installing an access door assembly in an air handling unit. The method includes providing the air handling unit having a plurality of walls, wherein at least one of the plurality of wall includes an opening, the opening having a perimeter. The method includes providing an access door assembly. The access door assembly further includes an access door and a structural member. The structural member further includes a plurality of frame pieces. The plurality of frame pieces further include a mounting flange, a segment, a first rolled surface adjacent to the mounting flange and the segment, a gasket channel, a second rolled surface adjacent to the segment and the gasket channel, an anti-compression leg, and a third rolled surface adjacent to the gasket channel and the anti-compression leg. The method includes arranging the plurality of frame pieces to form a generally rectangular framework on the perimeter of the opening of the wall. The method includes welding a portion of the adjoined plurality of frame pieces to form the structural member. The method includes securing the access door assembly to the perimeter of the opening of the wall by securing the mounting flange of the structural member to the wall of the air handling unit. The method includes providing a gasket, and inserting the gasket into the gasket channel which is disposed between the anti-compression leg and the segment. The anti-compression leg is operative to substantially prevent the door panel from over compressing the gasket disposed in the gasket channel.

Other features and advantages of the present invention will be apparent from the following more detailed description of the preferred embodiment, taken in conjunction with the accompanying drawings which illustrate, by way of example, the principles of the invention. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### BRIEF DESCRIPTION OF THE DRAWINGS

FIG. 1 is a perspective view of an air-handling unit according to an embodiment of the present disclosure.

FIGS. 2 and 3 provide side perspective views of an access door assembly in an opened position according to an embodiment of the present disclosure.

FIG. 4 is a front view of the access door assembly in a closed position according to an embodiment of the present disclosure.

FIG. 5 is a cross-section taken along 5-5 of FIG. 4 according to an embodiment of the present disclosure.

FIG. 6 is an enlarged partial view of FIG. 5 according to an embodiment of the present disclosure.

FIG. 7 is an enlarged partial top perspective view of FIG. 3 highlighting the exterior of the structural member according to an embodiment of the present disclosure.

FIG. 8 is a bottom perspective view of FIG. 7 highlighting a portion of the interior of the structural member according to an embodiment of the present disclosure.

Wherever possible, the same reference numbers will be used throughout the drawings to refer to the same or like parts.

### DETAILED DESCRIPTION OF THE EXEMPLARY EMBODIMENTS

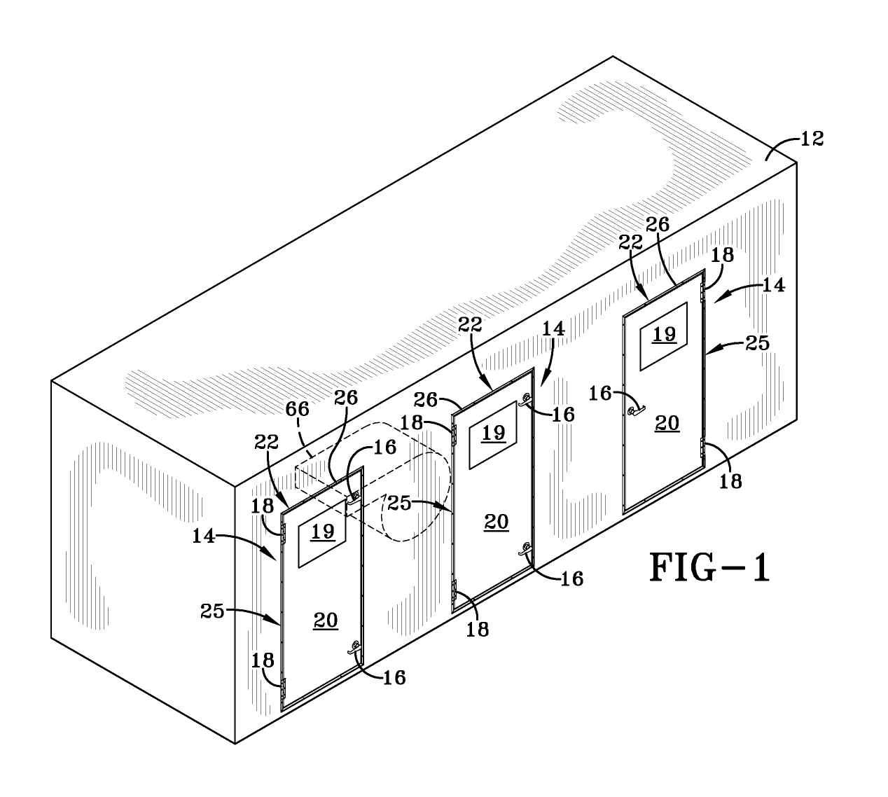

FIG. 1 is a perspective view of an air handling unit 12 for a HVAC unit. The air handling unit 12 further includes heating and/or cooling components 66, such as, for example, but not limited to, coils, fans, filters, and dampers. The air handling unit 12 further includes at least one opening or aperture 28 in a wall 30 having a perimeter 26 to allow access for maintenance of the heating and cooling components 66 within the air handling unit 12. An access door assembly 14 is attached to and disposed within the perimeter 26 of the opening 28. Depending on the size of the air handling unit 12, the number of access door assemblies 14 can be varied, from as few as one to an unlimited number of access door assemblies 14. The access door assembly 14 further includes a door panel 20, an assembled structural member 22 surroundingly encompassing the door panel 20, and a gasket 32. A portion of the structural member 22 attaches to and surrounds the perimeter 26 of the opening 28 on the wall 30. The structural member 22 includes a plurality of abutting frame pieces 24 that provide the framework to receive the door panel 20 (see FIG. 4). The door panel 20 is attached to the structural member 22 by a plurality of hinges 18 and fasteners (not shown). The door panel 20 can optionally include a window 19. The door panels 20 vary in size and construction, depending on the size and construction of the air handling unit 12. In one embodiment, the door panels 20 are approximately about one inch to approximately about three inches thick, and more preferably approximately about 1.5 inches to approximately about 2.5 inches thick, and even more preferably approximately about 1.5 inches to approximately about two inches thick. The door panels 20 are further constructed to have a double-wall construction of metal sheets for example, but not limited to, metal sheets of galvanized steel, stainless steel, or aluminum. In one embodiment, the door panel 20 is constructed from twenty-four gauge galvanized sheet steel with insulation between the sheets (not shown).

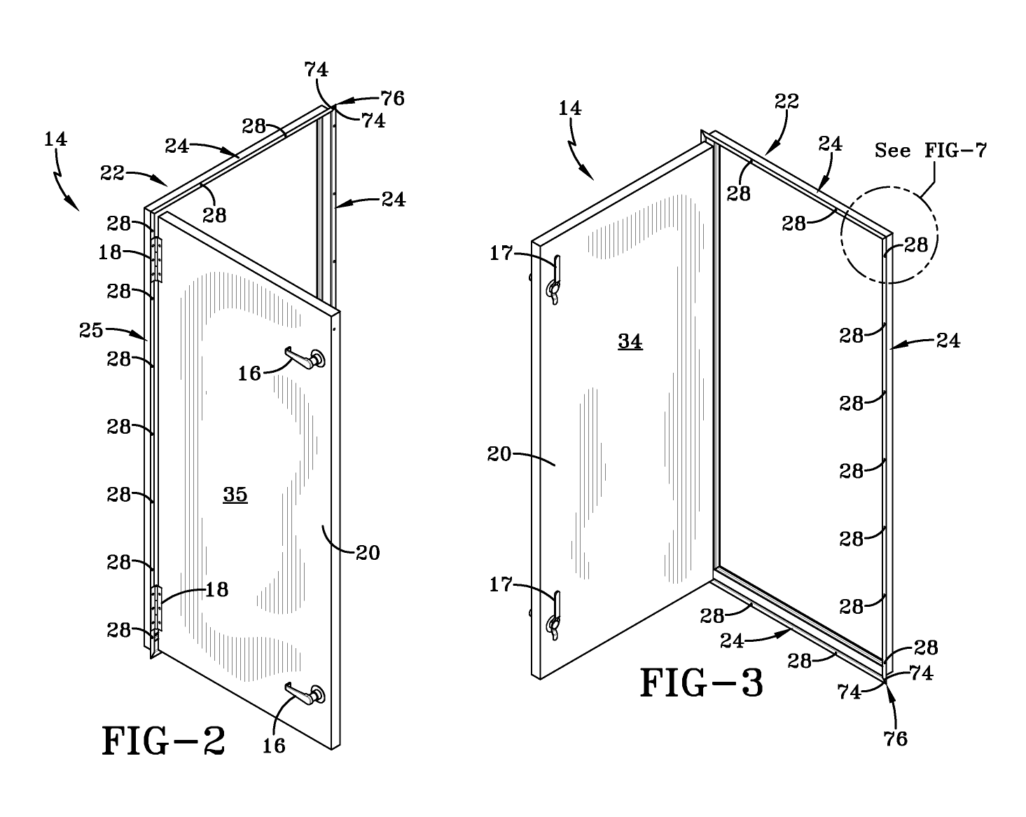

FIGS. 2 and 3 provide side perspective views of an access door assembly 14 with a door panel 20 in an open position. As shown in FIGS. 2 and 3 the door panel 20 is attached to at least one frame piece 24 of the structural member 22 with a plurality of hinges 18. In one embodiment, two or more sets of hinges 18 are used to secure the door panel 20 to at least one side of the structural member 22. The plurality of hinges 18 are attached to an exterior surface 62 of the structural member 22 and allow the door panel 20 to open preferably in an outward direction, away from the interior of the air handling unit 12. In one embodiment, the hinges 18 allow the door panel 20 to open preferably between at least 90 degrees and at least 270 degrees from the closed position. During normal operation of the HVAC unit, when maintenance is not necessary, the door panel 20 is held in a closed position by at least one latch 17 on the interior surface 34 of the door panel 20. The at least one latch 17 contacts a portion of the structural member 22 to hold the door panel 20 in a closed position. The exterior surface 35 of the door panel 20 includes at least one door handle 16 to release the at least one latch 17 and allow the door panel 20 to open. The at least one latch 17 holds the door panel 20 in a closed position and allows a fluid tight seal to form between the door panel 20 and the structural member 22, thereby preventing unnecessary leakage of air from within the air handling unit 12.

Referring to FIG. 4, a plurality of openings or apertures 28 are formed in each of the plurality of frame pieces 24 of the structural member 22. The plurality of apertures 28 allow sheet metal screws or other fasteners to secure or attach the access door assembly 14 to the wall 30 of the air handling unit 12. Each of the plurality of frame pieces 24 further include two ends 74, and each of the ends 74 are cut at a preselected angle, for example 45° angle. In constructing the structural member 22, angled end 74 of one frame piece 24 is brought into mutual abutment with another preselected angled end 74 for example 45° of another frame piece 24 to form a corner 76 of the structural member 22. The abutting angles are selected so that they form an angle of about 90° or a corner when assembled. The 45° angled ends 74 of the plurality of frame pieces 24 are positioned relative to each other to provide the rectangular framework of the structural member 22 to hold the door panel 20. The plurality of frame pieces 24 are joined to adjacent frame pieces 24 by joining means such as welding, adhesives, fasteners, and other techniques.

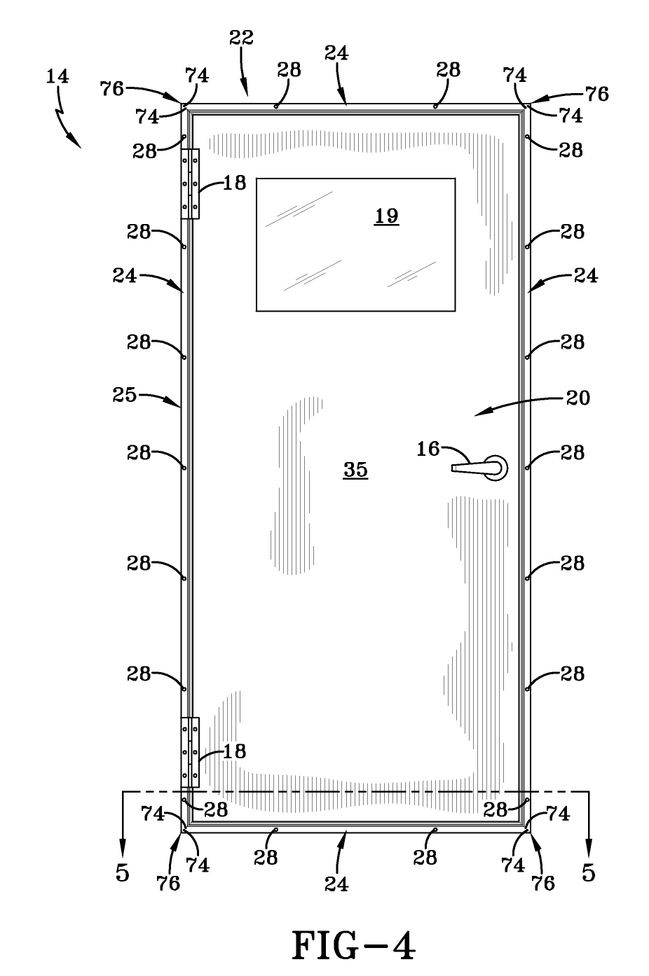

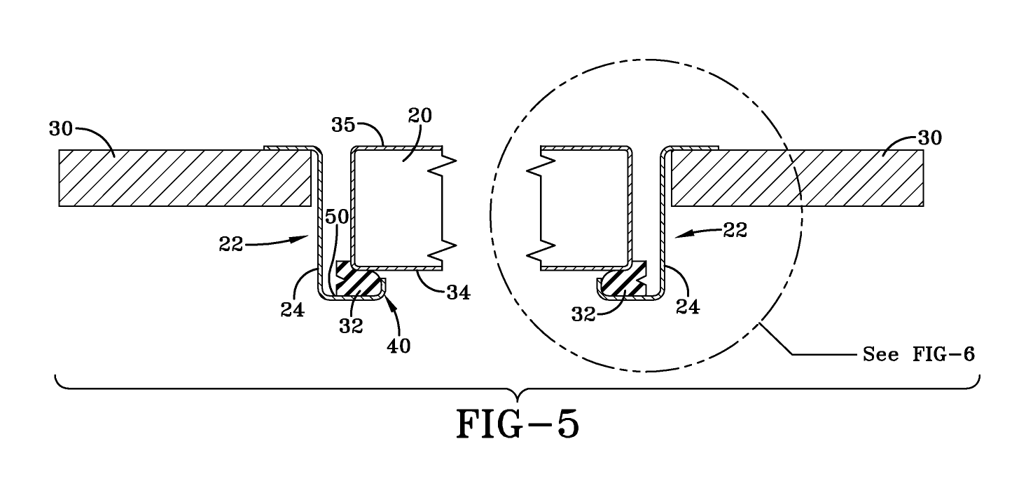

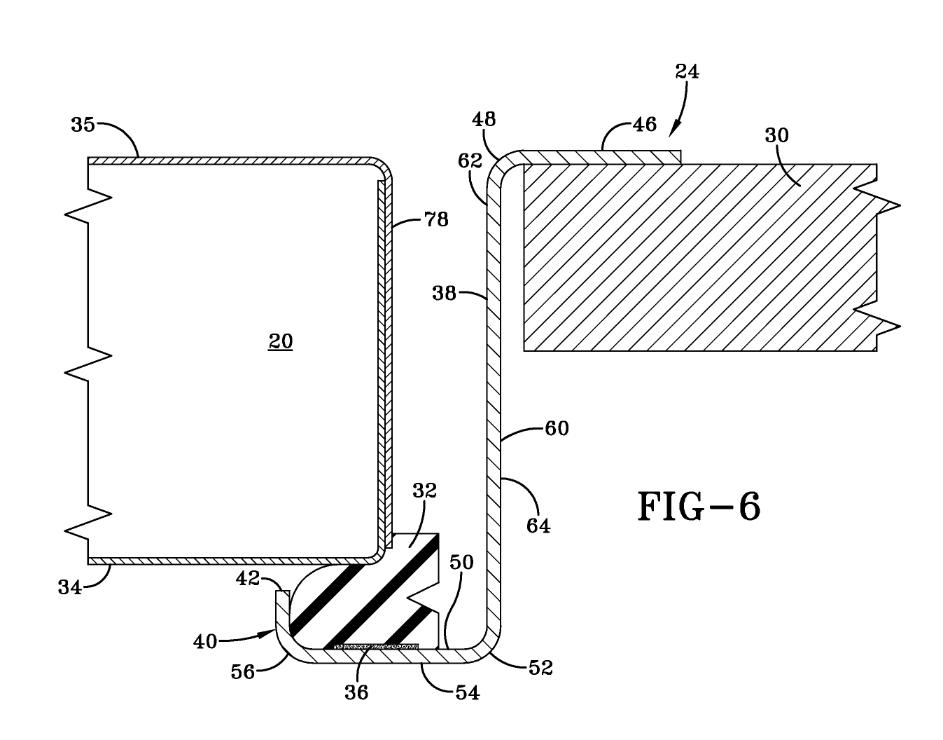

FIG. 5 is a downwardly looking cross section of FIG. 4 of the present disclosure. The plurality of frame pieces 24 of the structural member 22 are attached to the perimeter 26 of the opening 28 of the panel or wall 30 of the air handling unit 12 via fastening means such as sheet metal screws, nails, etc. (not shown) to secure the access door assembly 14 to the air handling unit 12. As shown in FIG. 5, a gasket 32 is disposed in a channel 50 between the door panel 20 and the structural member 22 to effectuate an air tight seal between the door panel 20 and the structural member 22 when the door panel 20 is in a closed and latched position. The gasket 32 is selected from a deformable or flexible material that can provide a substantially fluid tight seal and also prevents heat exchange between the controlled conditions maintained inside of the air handling unit 12 and ambient conditions exterior to the air handling unit 12. Examples of suitable gasket materials are but not limited to, metals, rubbers, plastics or polymers, corks, foams, and composite substances. In one embodiment the gasket material is selected from ethylene propylene diene monomer (EPDM) closed cell expanded rubber, neoprene rubber, nitrile rubber, viton rubber, thermoplastic elastomers, thermoplastic rubber, polyvinyl chloride, silicone, polytetrafluoroethylene (PTFE), and combinations thereof, or other materials that offer a fluid tight seal and prevent heat exchange. As shown in FIG. 6, the cross section of the frame piece 24 has a “Z-shaped” profile. The plurality of frame pieces 24 include an interior surface 60 and an exterior surface 62. Once the structural member 22 is mounted to the wall 30 of the air handling unit 12, the interior surface 60 of the frame piece 24 is generally located and/or facing the interior of the air handling unit 12 and not exposed to outside environmental elements, such as rain, wind, sun, and the like. The exterior surface 62 of the frame pieces 24 is generally located on and/or facing the exterior of the air handling unit 12 and is exposed to outside environmental elements. In one embodiment, the plurality of frame pieces 24 are formed from a single piece of rolled stainless steel, rolled galvanized steel, or other suitable materials which may include structural plastics and composites. Suitable gauges of stainless or galvanized steel for use in one present embodiment typically include 16 gauge, 18 gauge, and 20 gauge stainless or galvanized steel sheets.

In one embodiment, the plurality of frame pieces 24 are formed using a sheet metal rolling apparatus (not shown) to obtain a desired shape. The plurality of frame pieces 24 are rolled from a single piece of stainless or galvanized steel using a roll former. Using a roll former to produce the frame pieces 24 is a cost efficient method to manufacture high quality, high tolerance shapes. The roll formed sheet metal frame pieces 24 provide additional structural characteristics that are not obtainable from extruded frames, because the shape is formed from a single piece of metal. In contrast, the process used to form extruded frames causes inherent weaknesses in the extruded frames, and the assembly of the extruded frames requires the use of metal screws and fasteners. After the frame pieces 24 are formed or rolled to the desired “Z-shape,” the frame pieces 24 are further processed in the roll former. In one embodiment, the roll former additionally punches a plurality of mounting apertures 28 on each of the plurality of frame pieces 24, and shears the ends of each of the plurality of frame pieces 24 at a 45 degree angle for abutment. At least one of the frame pieces 24 is adapted to receive at least one of the hinges 18. This frame piece is a hinge frame piece 25. In one embodiment, during formation of the plurality of frame pieces 24, the roll former provides two incomplete punches per hinge 18 on the hinge frame piece 25. The plurality of hinges 18 are secured to the hinge frame piece 25 using a system such as the AKH Fas-Ner System®, available from AKH, Inc., Indianapolis, Ind., in which a rivet is used to punch through the hinge frame piece 25 and then the rivet is compressed. The compression of the rivet causes the rivet to expand to lock the hinge 18 and frame 25 together. In one embodiment, a self adjusting table and robotic welder are used to attach the plurality of frame pieces 24 together to form the substantially rectangular frame or structural member 22. In another embodiment, the plurality of frame pieces 24 are formed using plastic molds and heat to obtain a structural plastic with the desired shape. In yet another embodiment, the plurality of frame pieces are formed using composite molds, vacuums and heat to obtain a composite with the desired shape.

As shown in FIGS. 6-8, the Z-shaped frame piece 24 further comprises a mounting flange 46, a first roiled surface 48, a segment 64 for receiving the door panel 20, a second rolled surface 52, a gasket channel 50, a third rolled surface 56, and an anti-compression leg 40. The mounting flange 46 includes a plurality of apertures 28 to secure the assembled structural member 22 of the access door assembly 14 with a plurality of screws or other fasteners (not shown) to the wall 30 of the air handling unit 12. The first rolled surface 48 is disposed between the mounting flange 46 and the segment 64. As shown in FIG. 6, the first rolled surface 48 is rolled at an approximately 90 degree angle between the mounting flange 46 and the segment 64, such that the first rolled surface 48 abuts and generally conforms to the edge of the wall 30 of the air handling unit 12. The segment 64, which includes, a door panel receiving surface 38, is at an approximately 90 degree angle from the mounting flange 46, and provides an area to house or receive the side 78 of the door panel 20 in the structural member 22.

As shown in FIG. 6, when the door panel 20 is in a closed position, the segment 64 and the door panel receiving surface 38 are adjacent to the side 78 of the door panel 20. The second rolled surface 52 is disposed between the door panel receiving surface 38 and the gasket channel 50. The second rolled surface 52 is rolled at an approximately 90 degree angle such that the second rolled surface 52 is a mirror image of the first rolled surface 48 with respect to the segment 64. The gasket channel 50, which is created by the second rolled surface 52 and the third rolled surface 56, provides an area to receive the gasket 32 in the plurality of frame pieces 24. When the plurality of frame pieces 24 are assembled to create the structural member 22, the gasket channel 50 creates a rectangular channel surrounding the inner perimeter of the structural member 22. The gasket 32 is usually provided in a strip-like form and the gasket 32 is situated in the gasket channel 50 surrounding the inner perimeter of the structural member. In one embodiment, the gasket 32 is adhered to the gasket channel 50 of the structural member 22 by an adhesive 36 although it may also be fastened within channel 50. In another embodiment, the gasket 32 is secured in the channel by friction fit or interference fit. The third rolled surface 56, which defines a portion of the gasket channel 50, includes an anti-compression leg 40. As shown in FIG. 6, the third rolled surface 56 is rolled at an approximately 90 degree angle from a latch catch 54 and the anti-compression leg 40, although other examples may also be used. That is, the third rolled surface 56 includes the anti-compression leg 40 of the frame piece 24. The anti-compression leg 40 includes a rim 42 that functions as a stop surface to prevent the door panel 20 from over-compressing, grossly deforming, or smashing the gasket 32 when the door panel 20 is in a closed position. When the door panel 20 is in a closed position, the rim 42 or flange of the anti-compression leg 40 provides a stop for the interior surface 34 of the door panel 20, and prevents the door panel 20 from over-compressing and damaging the gasket 32. More specifically, as the door panel 20 is swung toward a closed position, the rim 42 or flange of the anti-compression leg 40 stops the door panel 20, and prevents the door panel 20 from over-compressing and damaging the gasket 32. The latch catch 54 accepts the latch 17 (see FIG. 3) of the door panel 20 to hold the door panel in a closed position. The latch catch 54 is situated along the interior surface 60 of the frame piece 24 of the structural member 22 to maintain the door panel 20 in a closed position and provide a fluid tight seal between the structural member 22 and the door panel 20 of the access door assembly 14.

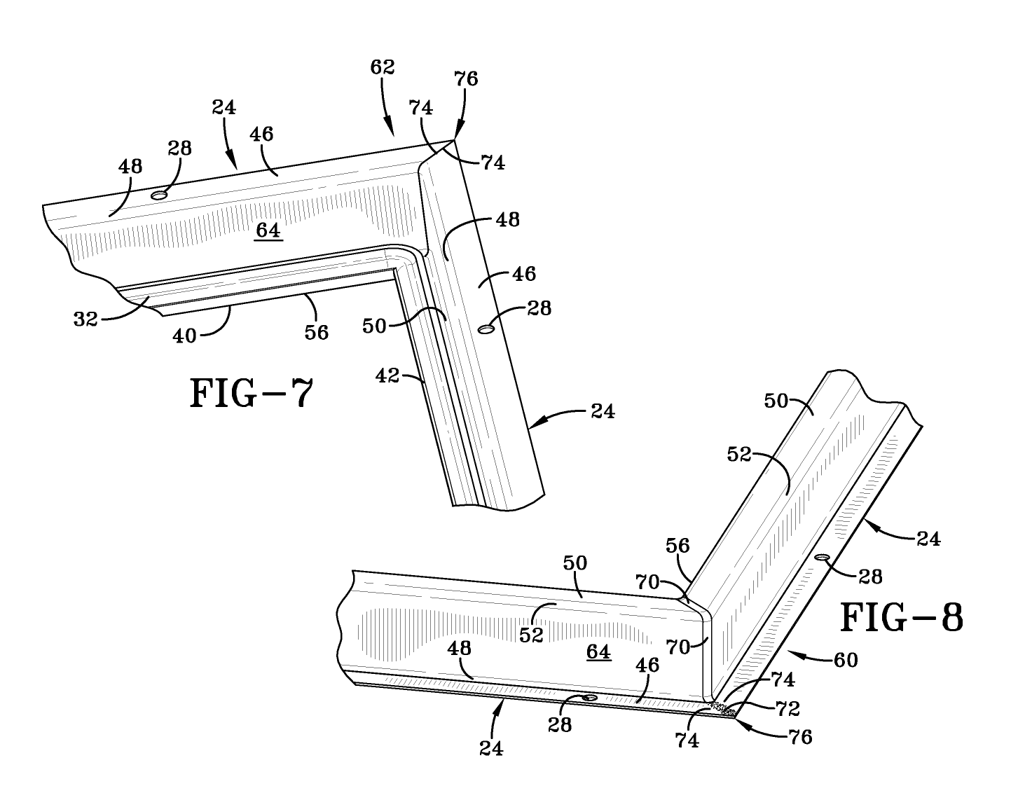

As shown in FIGS. 7 and 8, the ends 74 of two frame pieces 24 are joined by a weld 70 to form a corner 76. In one embodiment, as shown in FIG. 8, the weld 70 joins frame pieces 24 along ends 74 of each of the frame pieces 24 from the anti-compression leg 40 to the mounting flange 46. In another embodiment, the weld 70 joins ends 74 of the frame pieces 24 along the interior surface 60 from the first rolled surface 48 to the third rolled surface 56. In yet another embodiment, to provide a more air-tight seal between the ends 74 of the frame pieces 24, a sealant 72 is applied to the interior surface 60 of the ends 74 of the frame pieces 24 along the mounting flange 46 to the first rolled surface 48. Examples of suitable sealants 72 include, but are not limited to, polyurethane sealants, acrylic sealants, or silicone sealants.

The exterior surface 62 of the two joined frame pieces 24 is shown in FIG. 7. No welds are necessary on the exterior surface 62 of the frame pieces 24, the weld 70 and/or sealant 72 disposed on the interior surface 60 (see FIG. 8) of the frame pieces 24 provides the necessary structural integrity and fluid tight seal for the assembled structural member 22. In an alternative embodiment, the weld 70 joins the frame pieces 24 along ends 74 of each of the frame pieces 24 from the anti-compression leg 40 to the mounting flange 46 on both the interior surface 60 and the exterior surface 62. In yet another embodiment, the weld 70 joins frame pieces 24 along ends 74 of each of the frame pieces 24 from the anti-compression leg 40 to the mounting flange 46 along the exterior surface 62. As shown in FIG. 7, the gasket 32 is located in the gasket channel 50 and adjacent to the anti-compression leg 40. For an effective fluid tight seal to form, the gasket 32 location should be within a preselected distance from the anti-compression leg 40, preferably less than about 1 millimeter from the anti-compression leg 40.

In the present disclosure, butt joints are not necessary at the corners 76, because the angled ends 74 of each of the plurality of frame pieces 24 necessarily align when the frame pieces 24 are abutting. The present disclosure reduces the labor necessary to create the access door assembly 14, by reducing the number of steps needed to form the structural member 22. The present disclosure also reduces the time necessary to install the access door assembly 14. An additional benefit of the present disclosure is that additional glues and sealants are not necessary to get a substantially fluid or air-tight seal. The anti-compression leg 40 and rim 42 of the present disclosure acts as a stop to prevent over-compression of the gasket 32 which increases gasket life and increases overall thermal efficiency properties of the air handling unit.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1) An air handling unit comprising:
a plurality of walls;
at least one of the walls having an aperture with a perimeter; and
at least one access door assembly located in the perimeter of one of the plurality of walls, the access door assembly further including:
a door panel;
a structural member surroundingly encompassing the door panel, and secured to the perimeter the structural member having a plurality of frame pieces, the plurality of frame pieces further including:
a mounting flange;
a segment;
a first rolled surface adjacent to the mounting flange and adjacent to the segment;
a gasket channel;
a second rolled surface adjacent to the segment and adjacent to the gasket channel;
an anti-compression leg; and
a third rolled surface adjacent to the gasket channel and adjacent to the anti-compression leg; and
a gasket, wherein the gasket is disposed in the gasket channel and adjacent to the anti-compression leg and the segment;
wherein the anti-compression leg is operative to substantially prevent the door panel from over-compressing the gasket; and
fastening means to attach the door assembly to the perimeter of the wall.

2) The air handling unit of claim 1, wherein the structural member further includes at least one hinge, wherein the at least one hinge attaches the door panel to the structural member.

3) The air handling unit of claim 1, wherein each of the plurality of frame pieces are formed from a single piece of material selected from the group consisting of sheet metal, structural plastic, and composites.

4) The air handling unit of claim 3, wherein the plurality of frame pieces are formed using a roll former when the frame pieces are sheet metal.

5) The air handling unit of claim 1, wherein the cross-section of the plurality of frame pieces is generally Z-shaped.

6) The air handling unit of claim 1, wherein the plurality of frame pieces are cut to preselected angles at each end that total approximately ninety degrees when joined together, and wherein the ends of the plurality of frame pieces are joined together to form a plurality of corners of the structural member.

7) The air handling unit of claim 6, wherein the joined ends of the plurality of frame pieces are welded on an interior surface of the plurality of frame pieces.

8) The air handling unit of claim 7, wherein the joined ends of the plurality of frame pieces are sealed using a sealant on an interior surface of the plurality of frame pieces.

9) The air handling unit of claim 1, wherein the gasket is selected from a deformable material that that provides a substantially fluid tight seal and prevents heat exchange.

10) The air handling unit of claim 9, wherein the gasket material is selected from the group consisting of ethylene propylene diene monomer (EPDM) closed cell expanded rubber, neoprene rubber, nitrile rubber, viton rubber, thermoplastic elastomers, thermoplastic rubber, polyvinyl chloride, silicone, and polytetrafluoroethylene (PTFE).

11) An access door assembly comprising:
a door panel;
a structural member attached to a perimeter of a wall opening, the structural member surroundingly encompassing the door panel and having a plurality of frame pieces, the plurality of frame pieces further including:
a mounting flange;
a segment;
a first rolled surface adjacent to the mounting flange and the segment;
a gasket channel;
a second rolled surface adjacent to the segment and the gasket channel;
an anti-compression leg; and
a third rolled surface adjacent to the gasket channel and the anti-compression leg; and
a gasket, wherein the gasket is disposed in the gasket channel and adjacent to the anti-compression leg and the segment; and
wherein the anti-compression leg is operative to substantially prevent the door panel from over compressing the gasket disposed in the gasket channel.

12) The air handling unit of claim 10, wherein the structural member includes at least one hinge, wherein the at least one hinge attaches the door panel to the structural member.

13) The air handling unit of claim 10, wherein each of the plurality of frame pieces are formed from a single piece of material selected from the group consisting of sheet metal, structural plastic, and composites.

14) The air handling unit of claim 10, wherein the cross-section of the plurality of frame pieces is Z-shaped.

15) The air handling unit of claim 10, wherein the plurality of frame pieces are cut to preselected angles at each end that total approximately ninety degrees when joined together, and wherein the ends of the plurality of frame pieces are joined together to form a plurality of corners of the structural member.

16) The air handling unit of claim 15, wherein the joined ends of the plurality of frame pieces are welded on an interior surface of the plurality of frame pieces.

17) The air handling unit of claim 16, wherein the joined ends of the plurality of frame pieces are sealed using a sealant on an interior surface of the plurality of frame pieces.

18) The air handling unit of claim 1, wherein the anti-compression leg includes a rim that forms a stop for the door panel.

19) A method of installing an access door assembly in an air handling unit, the method including:
providing the air handling unit having a plurality of walls, wherein at least one of the plurality of walls includes an opening, the opening having a perimeter;
providing an access door assembly, wherein providing the access door assembly further includes:
an access door;
a structural member, wherein the structural member further includes:
a plurality of frame pieces, the plurality of frame pieces further including:
a mounting flange;
a segment;
a first rolled surface adjacent to the mounting flange and the segment;
a gasket channel;
a second rolled surface adjacent to the segment and the gasket channel;
an anti-compression leg; and
a third rolled surface adjacent to the gasket channel and the anti-compression leg; and
arranging the plurality of frame pieces to form a generally rectangular framework that surrounds the perimeter of the opening of the wall;
joining a portion of the adjoined plurality of frame pieces to form the structural member;
securing the access door assembly to the perimeter of the opening of the wall by securing the mounting flange of the structural member to the wall of the air handling unit;
providing a gasket; and
securing the gasket to the gasket channel, wherein the gasket is disposed between the anti-compression leg and the segment; and
wherein the anti-compression leg is operative to substantially prevent the door panel from over compressing the gasket disposed in the gasket channel.

20) The method of installing an access door assembly of claim 19, wherein the step of joining further includes applying a sealant to a portion of the adjoined frame pieces.
